(19) United States
(12) Patent Application Publication
(10) Pub. No.: US 2013/0297472 A1
(43) Pub. Date: Nov. 7, 2013

(54) Identify Potential Account Numbers in a Single Pass of a List of Digits

(71) Applicants: Matthew Richard Thomas Hall, Mountain View, CA (US); Reinoud Jelmer Jeroen Koornstra, Roseville, CA (US); Miranda Jane Felicity Mowbray, Bristol (GB)

(72) Inventors: Matthew Richard Thomas Hall, Mountain View, CA (US); Reinoud Jelmer Jeroen Koornstra, Roseville, CA (US); Miranda Jane Felicity Mowbray, Bristol (GB)

(21) Appl. No.: 13/885,942

(22) PCT Filed: Jan. 27, 2011
(86) PCT No.: PCT/US11/22709

§ 371 Date: May 16, 2013

(51) Int. Cl. G06Q 40/02

(52) U.S. Cl. CPC G06Q 40/02
USPC 705/35

(57) ABSTRACT

Embodiments disclosed herein relate to identifying potential account numbers in a single pass of a list of digits. A processor 104 may determine in a single pass of a list of digits each consecutive sequence of digits of a selected length satisfying a Luhn check. The processor 104 may provide the determined sequences of digits as potential account numbers.

### BACKGROUND

With an increase in online financial interactions, such as online banking and online retail, credit card numbers and other financial account numbers are often transmitted across networks. In some cases, an entity may create a data leak protection program to prevent unauthorized access and transmission of account numbers. For example, network traffic may be analyzed to determine whether it contains account number information. Account numbers, such as credit card numbers, may be designed to pass a Luhn check. A Luhn check may be used to determine whether a consecutive sequence of digits is a potential account number.

### BRIEF DESCRIPTION OF THE DRAWINGS

In the accompanying drawings, like numerals refer to like components or blocks, The drawings describe example embodiments. The drawings show methods performed in an example order, but the methods may also be performed in other orders. The following detailed description references the drawings, wherein:

FIG. 1 is a block diagram illustrating one example of an apparatus.

FIG. 2 is a block diagram illustrating one example of a computing system.

FIG. 3 is a flow chart illustrating one example of identifying potential account numbers.

FIG. 4 is a flow chart illustrating one example of a method for evaluating each digit in a list to identify potential account numbers in a single pass of the list.

FIG. 5 is a flow chart illustrating one example of a method for identifying consecutive sequences of 14, 15, and 16 digits passing a Luhn check.

FIG. 6 is a diagram illustrating one example of determining partial check information related to each position in a list of consecutive digits.

FIG. 7A is a diagram illustrating one example of filtering a list of characters.

FIG. 7B is a diagram illustrating one example of filtering a list of characters based on approved characters.

FIG. 8 is a flow chart illustrating one example of a method to process a sequence of digits satisfying a Luhn check.

### DETAILED DESCRIPTION

In one embodiment, a processor performs a single pass of a list of characters to identify both consecutive sequences of digits of a particular length and to identify which of the sequences of the particular length satisfy a Luhn check. Simultaneously checking for both the length and a Luhn check digit may use fewer computations than other methods. As a result, a system may be able to inspect more lists of characters, such as characters found in additional network packets. In addition, such a method may in some cases be simple enough to implement in hardware.

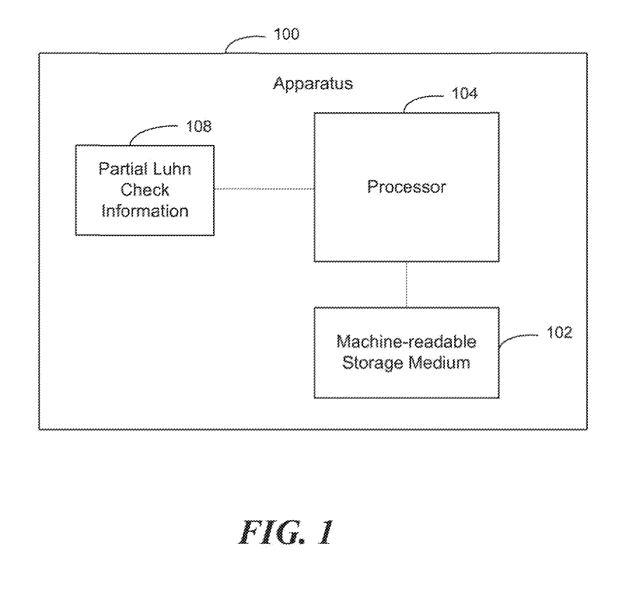

FIG. 1 is a block diagram illustrating one example of an apparatus 100. The apparatus 100 may be used, for example, to perform a single pass of a list of digits to determine each of the sequences of digits of a particular one or more lengths passing a Luhn check. For example, in a single pass of a list of digits, sequences of 14 digits that pass a Luhn check may be identified, such as for the list 1234567891234878 determining that the sequences of 14 consecutive digits are 12345678912348, 23456789123487, and 34567891234878 and determining whether these three sequences pass a Luhn check. The apparatus 100 may be any suitable electronic device, such as a web server, muter, or other computing device. The apparatus 100 includes a processor 104, a machine-readable storage medium 102, and partial Luhn check information 108.

The processor 104 may be any suitable processor, such as a central processing unit (CPU), a semiconductor-based microprocessor, or any other device suitable for retrieval and execution of instructions. In one embodiment, the apparatus 100 includes logic instead of or in addition to the processor 104. As an alternative or in addition to fetching, decoding, and executing instructions, the processor 104 may include one or more integrated circuits (ICs) or other electronic circuits that comprise a plurality of electronic components for performing the functionality described below. In one implementation, the apparatus 100 includes multiple processors. For example, one processor may perform some functionality and another processor may perform other functionality.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be for example, a computer readable non-transitory medium. The machine-readable storage medium 102 may include instructions executable by the processor 104.

In one embodiment, the processor 104, such as by executing instructions stored in the machine-readable storage medium 102, evaluates a list of digits to identify in a single pass of the list each of the consecutive sequences of digits of a particular length greater than zero that satisfy a Luhn check. For example, in a single pass of a list of digits 123456789012345, the processor 104 may determine each of the consecutive sequences of length 5 that satisfy the Luhn check.

The processor 104 may perform a single pass of the digits and store information in a storage as the processor 104 analyzes each digit. For example, the processor 104 may perform a partial Luhn check for a digit being evaluated and store the partial Luhn check information 108. The partial Luhn check information 108 may be stored in a storage, such as a volatile or non-volatile storage. The storage may be a storage included in the same electronic device as the processor 104 or may be included in a separate electronic device. For example, the storage may he a local storage or a remote database.

The partial Luhn check information 108 may be any suitable partial Luhn check information. The partial Luhn check information 108 may include information related to a partial Luhn check for multiple digits, such as where a partial Luhn check for a digit may be based on partial Luhn check information related to a digit in a previous position. The partial Luhn check information 108 may be accessed when analyzing the next digit to create the partial Luhn check for that digit. The processor 104 may complete the Luhn check after a proper number of digits have been analyzed. For example, for a selected length of 5 digits, the processor may complete a Luhn check for each position beyond the 5^{th} position. If the completed Luhn check reveals that a sequence of digits of the particular length satisfies the Luhn check, the sequence of digits may he a potential account number. Further processing may be performed to determine if a potential account number is an actual account number.

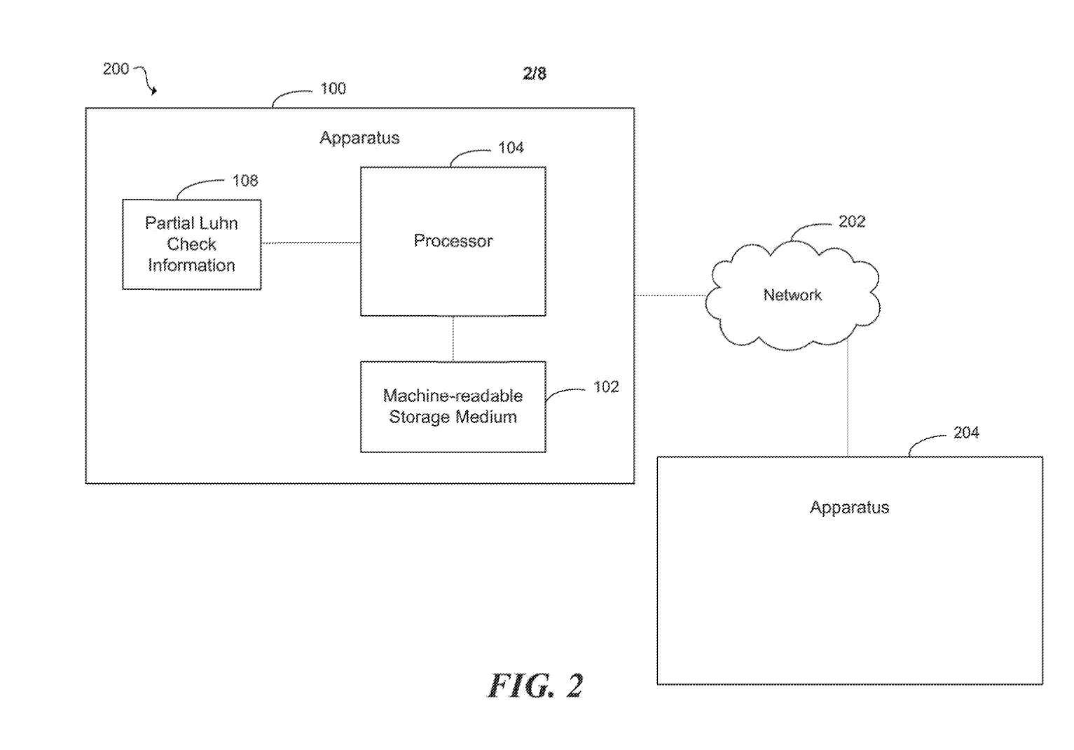

FIG. 2 is a block diagram illustrating one example of a computing system 200. The computing system 200 includes the apparatus 100, a network 202, and an apparatus 204. The apparatus 100 may receive a list of digits from the apparatus 204 via the network 202. The apparatus 204 may be any suitable electronic device, such as a web server. The network 202 may be any suitable network, such as a local area network, a wireless local area network, or the Internet. The network 202 may transmit packets of data, and in some cases the data may include sequences of consecutive numerical digits. The apparatus 100 may communicate with the network 202. For example, the apparatus 100 may evaluate traffic being transmitted across the network 202 to determine whether the traffic includes account numbers, such as unauthorized credit card numbers. The apparatus 100 may individually analyze characters found within each network packet, or may receive a group of data contained in multiple packets.

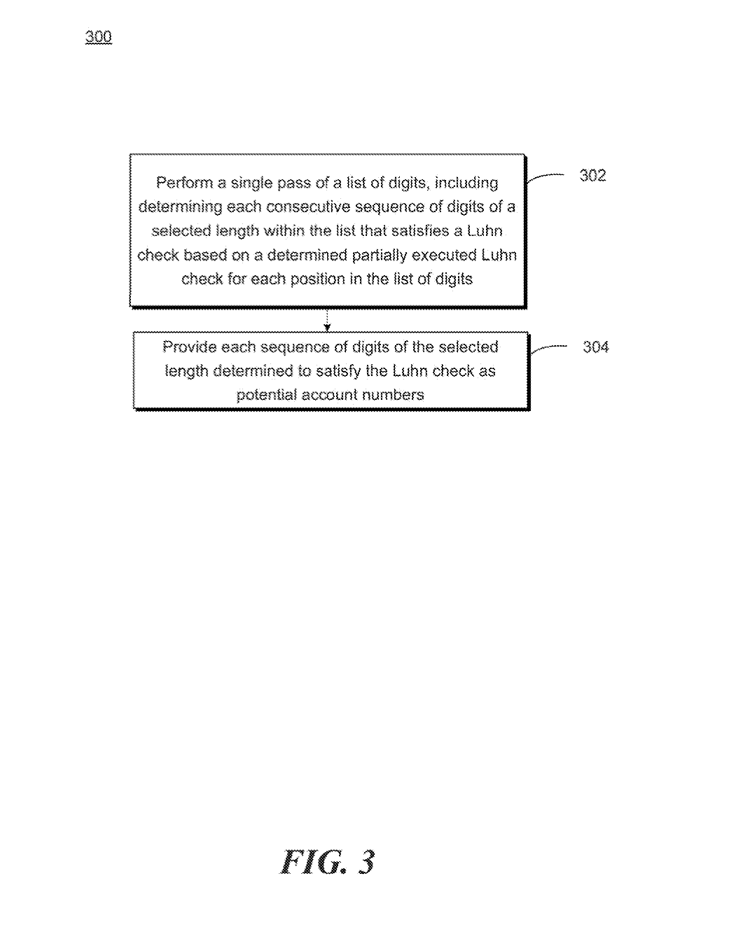

FIG. 3 is a flew chart illustrating one example of a method 300 for identifying potential account numbers. Potential account numbers may be identified by analyzing a list of digits to determine each sequence of a particular length within the list satisfying a Luhn check. Each digit within the list may be evaluated once. For example, partial Luhn check information may be determined for each digit in the list. The partial Luhn check information may be used to determine whether a consecutive set of digits of a particular length ending with a digit being evaluated satisfies a Luhn check. Consecutive sequences of digits of a particular length that satisfy the Luhn check may be provided, such as outputted to another electronic device, displayed, or stored. The method 300 may be executed, for example, using the apparatus 100.

Beginning at 302, a processor performs a single pass of a list of digits, including determining each consecutive sequence of digits of a selected length within the list that satisfies a Luhn check based on a determined partially executed Luhn check for each position in the list of characters. The processor may be any suitable processor, such as a processor executing instructions stored in a machine-readable storage medium or a processor implemented in hardware. In one implementation, the processor is the processor 104.

The consecutive sequence of digits may be any suitable sequence of digits. In some cases, the digits may be separated by other characters that are skipped during the analysis. For example, 2d9j9 may be evaluated as a consecutive sequence of digits 299. The selected length may be any suitable length. In some cases, there are multiple selected lengths. For example, a particular type of account number may have a length of 10 or 11 digits, and sequences of digits of both lengths may be checked during a single pass through the list of digits.

A Luhn check involves multiplying digits in an even position by 2 for odd length numbers, and multiplying digits in an odd position by 2 for even length numbers. For example, for a number 12345 of length 5, the digits 2 and 4 are multiplied by 2. For a number 123456 of length 6, the digits 1, 3, and 5 are multiplied by 2. As a result, the last digit is not one of the multiplied numbers. For a sample number 4408041234567893 of length 16 each digit in an odd position is multiplied by 2 such that (4*2) 4 (0*2) 8 (0*2) 4 (1*2) 2 (3*2) 4 (5*2) 6 (7*2) 8 (9*2) 3 becomes 8 4 0 8 0 4 2 2 6 4 10 6 14 8 18 3. A Luhn check then involves adding the digits of these resulting numbers. The sum of the digits for the sample number is 8+4+0+8+0+4+2+2+6+4+(1+0)+6+(1+4)+8+(1+8)+3=70. The mod 10 value of the summed result is determined. If the result of the mod 10 operation is 0, then the number passes the Luhn check, if the result of the mod 10 operation is not 0, then the number fails the Luhn check. Because 70 mod 10 equals 0, the sample number 4408041234567893 passes the Luhn check.

The partial Luhn check information may be any suitable partial Luhn check information, such as the partial Luhn check information 108. The partial Luhn check information may include any suitable information related to determining a Luhn check of a sequence of digits. For example, the partial Luhn check may be performed as part of the steps of the Luhn check, such as a step to multiply digits by 2, add digits, or mod a sum by 10.

The partial Luhn check information may be determined for each position the list. For example, for a list of digits 189823, a partial Luhn check may be determined for position 1 for the digit 1, position 2 for the digit 8, position 3 for the digit 9, and continuing for each position in the list. Partial Luhn check information for a digit in a subsequent position may be based on the partial Latin check information of a digit in a previous position. For example, the partially executed Luhn check for the digit 9 in position 3 may be based on the partially executed Luhn check for the digit 8 in position 2.

The partially executed Luhn check information may be used to determine whether a sequence of digits of a particular length satisfies a Luhn check in any suitable manner. Creating the partial Luhn check information may allow each sequence in a list of digits of a particular length that pass a Luhn check to be identified from evaluating each digit once. For example, for a sequence of digits 12345789 for a selected length of 4, the processor may subtract partial Luhn check information related to the digit 4 in the fourth position from the partial Luhn check of the digit 8 in the eighth position. In some cases, the Luhn check may be completed differently depending on whether the selected length is an even or odd number.

Continuing to 304, the processor provides each sequence of digits of the selected length determined to satisfy the Luhn check as potential account numbers. For example, the processor may store the sequences of digits for later access. In one embodiment, the processor performs further processing or transmits the sequences of digits to another electronic device for further processing, such as to determine whether the potential account numbers are actual account numbers. For example, sequences of digits may satisfy a Luhn check even if the sequences are not associated with account numbers. The processor may analyze potential account numbers to determine if they match other patterns indicating a possible account number. For example, a group of the first digits of the account numbers may be compared to sequences of digits used by companies issuing account numbers, such as where company X begins each of its account numbers with 2366. Sequences of digits of the particular length passing the Luhn check that do not match the additional patterns may be determined not to be account numbers.

The processor may send the potential account numbers to a company associated with the potential account numbers. For example, account numbers associated with a particular credit card number may begin with a particular digit or be a particular length. The processor may send each sequence passing the Luhn check to a company that may be associated with the account. The processor may then receive information indicating whether the sent account numbers are actual valid account numbers.

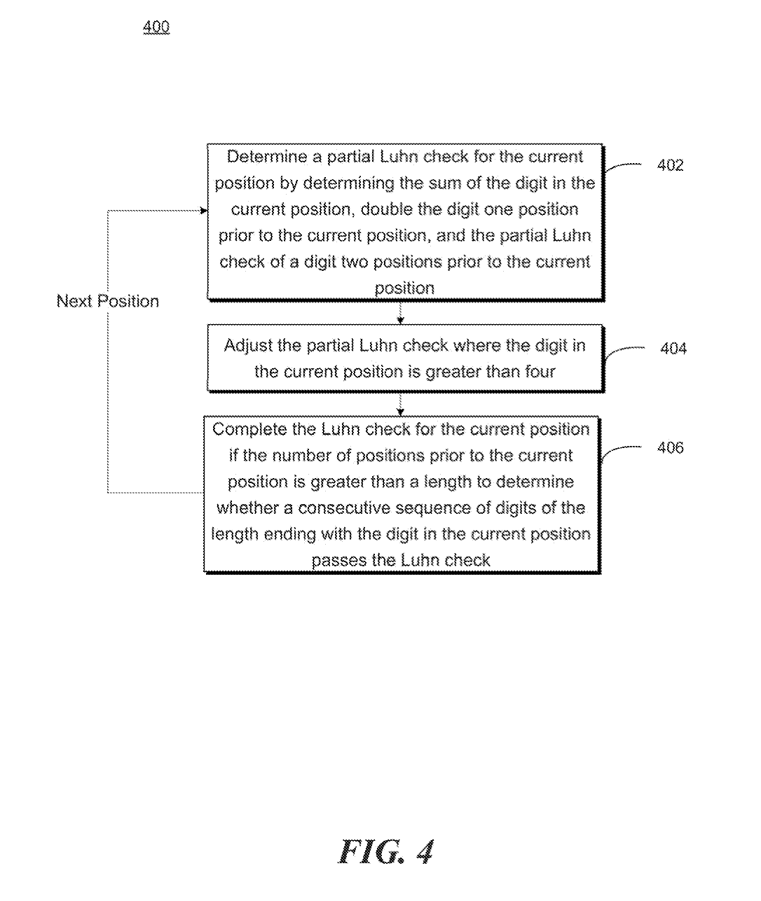

FIG. 4 is a flow chart illustrating one example of a method 400 for evaluating each digit in a list to identify potential account numbers in a single pass of the list. A processor may evaluate a list of digits in a single pass such that each position in the list is evaluated once. For example, a partial Luhn check may be performed based on each position in the list as it is evaluated, and a Luhn check may be completed based on the partial Luhn check of the position being evaluated. The method 400 may be executed, for example, using the apparatus 100.

Beginning at 402, a processor determines a partial Luhn check for the current position by determining the sum of the digit in the current position, double the digit one position prior to the current position, and the partial Luhn check of a digit two positions prior to the current position. The processor may read in each digit in the list and process it. The operation may be performed differently for the first and second positions. If the current position is in the first position in the list, the partial Luhn check may be the first digit. If the current digit is in the second position in the list, the partial Luhn check may be based on the digit in the second position, double the digit in the first position, and a zero value for the partial Luhn check of two positions prior to the second position. The partial Luhn information may be stored, such as in an array list, or other data structure, such as a PartialLuhn[] array where each position in the array represents a position in the list of digits. For example, PartialLuhn[2] may represent the partial Luhn information for a second position in a list of digits. Other operations may also be performed. For example, other steps may be added. In some cases the steps may be performed in a different order.

As an example, for a list of digits 12345, PartialLuhn[0]=0, PartialLuhn[1]=1, PartialLuhn[2]=PartialLuhn[0]+2*1+2=4. PartialLuhn[3]=PartialLuhn[1]+2*2+3=8, and PartialLuhn[4]=PartialLuhn[2]+2*3+4=14. The partial Luhn information for 5 may be broken down as the following to show that partial Luhn information represents multiplying every other digit by 2:

PartialLuhn[5]=PartialLuhn[3]+2*4+5

PartialLuhn[5]=PartialLuhn[1]+2*2+3+2*4+5

PartialLuhn[5]=1+2*2+3+2*4+5

Proceeding to 404, the processor adjusts the partial Luhn check where the digit in the current position is greater than four. For example, an operation may be performed to adjust multiple digit results of the doubling operation. When multiplying a number by 2, the processor may use the individual digits for the sum instead of the result for double digit results. In one embodiment, the processor uses the result of the doubling operation and adds one to the result if the number multiplied by two is greater than 4. For example, for each 5*2=10, 6*2=12, 7*2=14, 8*2=16, 9*2=18, the result includes a 1 that would be added to the sum. A mod 10 operation involves determining whether a right most digit in a number is a zero. Adding a 1 instead of adding the two digits that result from the multiplication may result in a different total number, but the right most digit that is considered in the mod 10 operation remains the same with either method of adjusting for numbers greater than 4.

Moving to 406, the processor completes the Luhn check for the current position if the number of positions prior to the current position is greater than a length to determine whether a consecutive sequence of digits of the length ending with the digit in the current position passes the Luhn check. The Luhn check may be completed during the evaluation of a position where the current position is greater than the length. For example, for a list of digits 1234839092, if the current position is the 8^{th} position and the determined length is 7, the processor may complete the Luhn check for the sequence 2348390 of 7 consecutive digits where the 0 in the 8^{th} position is evaluated.

The Luhn check may be completed in any suitable manner. The completed Luhn check may be based on a determined partial Luhn check. In one embodiment, the method for completing the Luhn check depends on whether the selected length is even or odd. For example, for an even length, the partial Luhn check of a digit the selected length from the current position may be subtracted from the partial Luhn check of the digit in the current position. For an odd length, the partial Luhn check of a digit one less than the selected length from the current position may be subtracted from the partial Luhn check of the digit in the current position, and then the digit in a position one less than the selected length from the current position may be added.

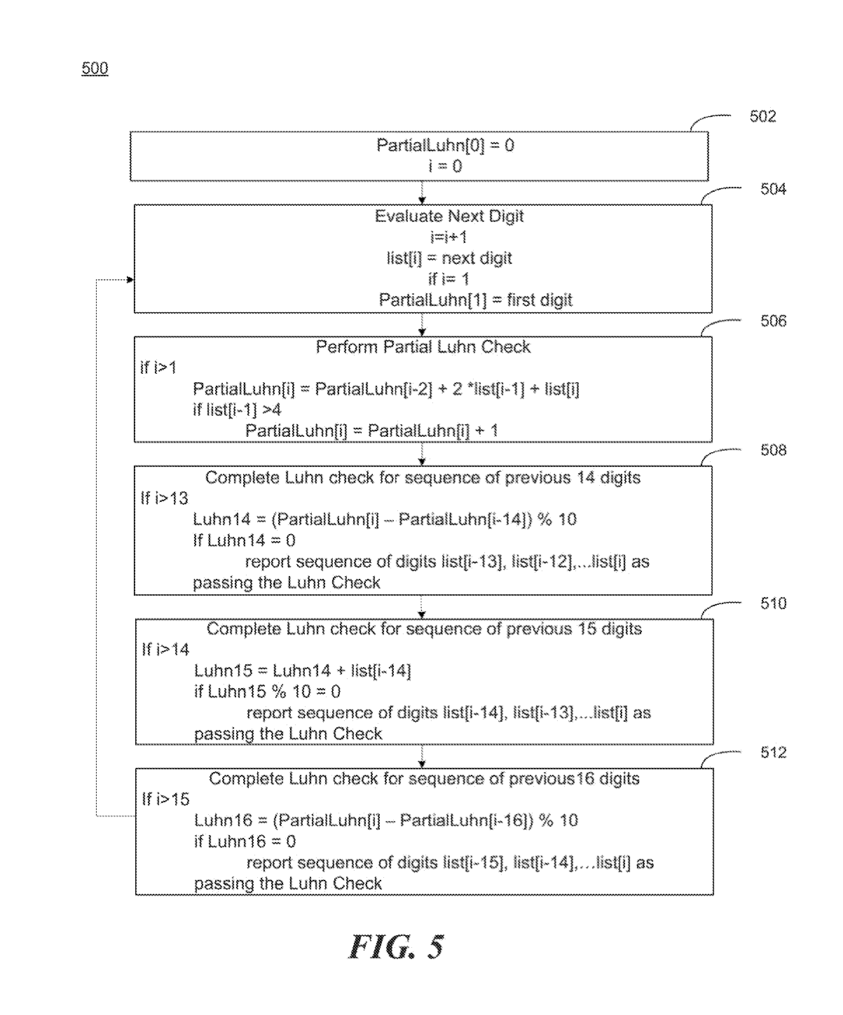

After the calculation of any relevant completed Luhn checks for the current position, the current position may he updated to the next position in the list of digits, and the processor may then determine partial Luhn check information for the new current position. This is illustrated in FIG. 4 by the arrow from 406 to 402. For example, referring back to the example sequence 1234839092, the processor may then evaluate the 9 in the 9^{th} position and complete the Luhn check for the consecutive sequence of digits 23483909. FIG. 5 is a flow chart illustrating one example of a method 500 for identifying consecutive sequences of 14, 15, and 16 digits passing a Luhn check. In one embodiment, a processor identifies potential account numbers of 14, 15, or 16 digits within a list of digits. A number variable, such as a variable i, may represent the current position in a list of digits. For example, where i=1, it represents the first position in a list. The variable i may be incremented for each position evaluated such that it reflects the current position being evaluated. The processor may also populate an array, list, or other data structure representing the list of digits evaluated. As each digit is evaluated, it may be added to a list[] data structure. The partial Luhn information may be an array or other data structure that the processor populates with partial Luhn check information related to a digit being evaluated. For example, the PartialLuhn[] array stores partial Luhn information for each position such that PartialLuhn[6] represents partial Luhn information for a 6^{th} position. The method 500 shows a variable Luhn14 for determining whether a sequence of 14 digits passes a Luhn check, a variable Luhn15 for determining whether a sequence of 15 digits passes a Luhn check, and a variable Luhn16 for determining whether a sequence of 16 digits passes a Luhn check. Beginning at block 502, the variables are initialized. PartialLuhn[0] is set to 0 and i is set to 0. Moving to block 504, the next digit is evaluated. The processor increments i one position, such that it is at 1 for the first position. The list array has the number in the current position added to the array. The list array is a list of the previous numbers evaluated and the current number being valuated. If i equals 1, meaning that the digit in the first position is being evaluated, PartialLuhn[1] is set to equal this digit.

At 506, a processor determines partial Luhn information if i is greater than 1. The partial Luhn information includes: PartialLuhn[i−2]+2 * list[i−1]+list[i]. The list[i] value is the digit in the current position. The list[i−1] is the digit in the previous position which is multiplied by 2. The PartialLuhn[i−2]is equal to the PartialLuhn value associated with the digit in two positions prior to the current position. In some cases, the processor may adjust the PartiaiLuhn[i] to account for double digit numbers multiplied by 2. For example if the digit in the position list[i−1] that was multiplied by 2 is greater than 4, the processor may add 1 to the PartialLuhn[i].

A processor may continue to determine the partial Luhn information for each position in the list. When the number of evaluated digits reaches 14, one of the selected lengths, the processor may complete a Luhn check to determine if the list of 14 digits ending with the current digit satisfies a Luhn check. At 508, the processor determines whether i is greater than 13 to determine if more than 13 digits have been evaluated. If i is greater than 13, the processor performs a Luhn check of Luhn14=(PartialLuhn[i]−PartialLuhn[i−14]) % 10. The partial Luhn check for the 14^{th} position prior to the current position is subtracted so that Luhn14 is determined by the value of 14 consecutive digits. If Luhn14 equals 0, it indicates that the sequence of 14 consecutive digits ending with the current digit satisfies the Luhn check. The sequence may be an account number. Each time the processor evaluates a digit where i is greater than 14, the processor determines whether the sequence of 14 consecutive digits ending with the current digit passes the Luhn check.

At 510, a processor determines whether a sequence of 15 consecutive digits ending with the current digit satisfies a Luhn check. if i is greater than 14, the processor determines both whether the sequence of 14 and 15 consecutive digits ending with the current digit satisfy a Luhn check. A Luhn15 value equals Luhn14+list[i−14]. For odd length sequences of digits, the Luhn check involves multiplying even numbered digits by two. Instead of subtracting the PartialLuhn[i−15] from the current PartialLuhn value, the Luhn check may be determined by adding the Luhn14 digit to the digit prior to the digits included in the Luhn14 partial Luhn information such that the first digit is not multiplied by 2. If Luhn15 % 10 is equal to zero, the processor may report that the sequence of 15 consecutive digits ending with the current digit satisfies a Luhn check. The sequence satisfying the Luhn check may or may not be an account number, but the fact that a sequence passes the Luhn check may indicate that a sequence of consecutive digits should be analyzed further to determine if it is a valid account number.

At 512, the processor checks whether the sequence of 16 consecutive digits ending with the current digit satisfies the Luhn check. The processor may check whether i is greater than 15. If it is greater than 15, the processor may determine a Luhn16 value equal to (PartialLuhn[i]−PartialLuhn[i−16]) % 10. The Luhn16 value may be based on the partial Luhn information of the current position subtracting out partial Luhn information more than 16 positions prior to the current position. A mod 10 operation may then be performed on the result. If the Luhn16 value equals zero, the processor may report that the sequence of 16 consecutive digits ending with the current digit passes the Luhn check. The sequences passing, the Luhn check may be account numbers. The method 500 may then continue to 504 to evaluate the next digit in the list.

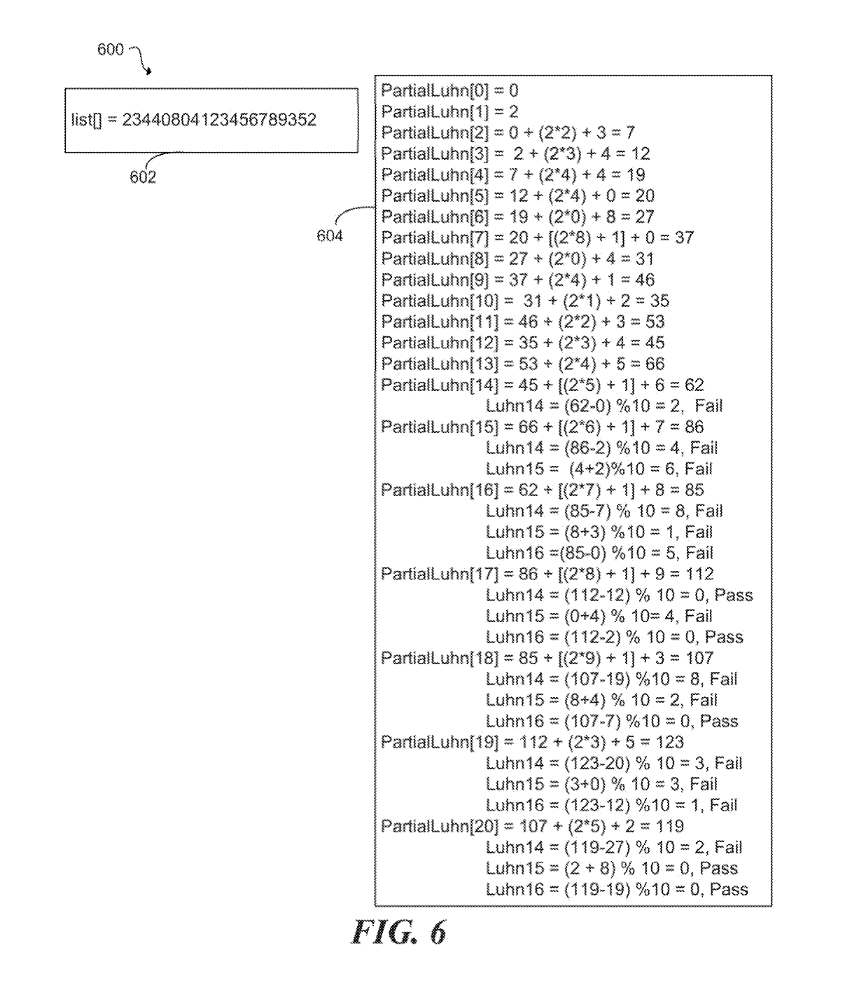

FIG. 6 is a diagram illustrating one example 600 of determining partial Luhn information related to each position in a list of consecutive digits using the method 500. The example 600 at 602 shows a sample list of digits 23440804123456789352, The sample list of digits is shown in the subset array. Block 604 shows the PartialLuhn value for each position in the list of digits and the Luhn14. Luhn15, and Luhn16 values. For example, where i=17, PartialLuhn17, Luhn14, Luhn15, and Luhn16 are each determined. The sequences of consecutive digits of lengths 14 to 16 shown to pass the Luhn check are the 14 digit sequence ending at the 17^{th} digit, 40804123456789; the 15 digit sequence ending at the 20^{th} digit, 804123456789352; and the 16 digit sequences ending at the 17^{th}, 18^{th} and 20^{th} digits, 3440804123456789, 4408041234567892, and 0804123456789352 respectively. The five sequences of digits passing the Luhn check may be account numbers.

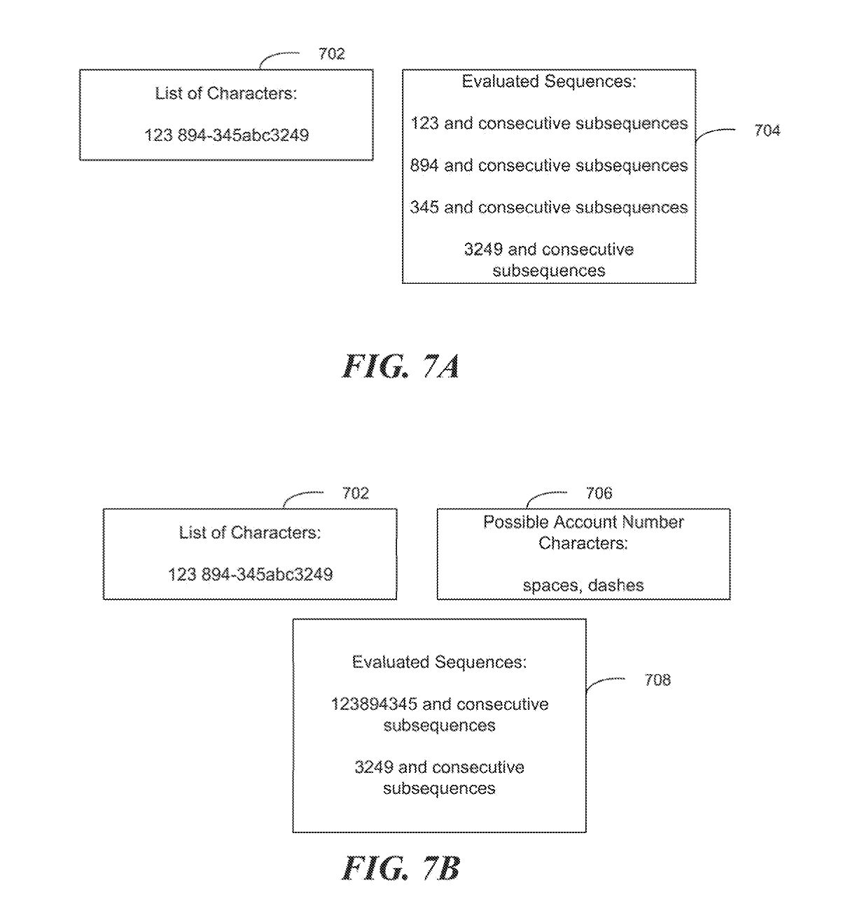

FIG. 7A is a diagram illustrating one example of filtering a list of characters. In some cases, a processor may start a Luhn check method over each time a digit is found after a non-digit. For example, for a list 1299 3933k322, a Luhn check may be performed on the sequences 1299, 2933, 322, and the consecutive subsequences of each, such as for 1299 the subsequences 1, 12, 129, 1299, 2, 29, 299, 9, 99, and 9. Block 702 shows an example list of characters 123 894-345abc3249. Block 704 shows that the sequences 123, 895, 345, and 3249 and their consecutive subsequences may be evaluated.

FIG. 7B is a diagram illustrating one example of filtering a list of characters based on approved characters. In one embodiment, a processor receives a list of characters that may include digits as well as other types of characters. In one embodiment, a processor may skip over particular approved characters without starting over a Luhn check method. Block 702 shows the example list of characters 123 894-345abc3249, Block 706 shows approved non-digit characters. The characters may be, for example, the types of characters that may be likely to be entered when entering an account number, such as spaces and dashes, Block 708 shows that of the sequences and subsequences 123894345 and 3249 may be tested to determine if they satisfy a Luhn check. For example, 1238 is tested because a space is an approved character, and therefore, does not indicate that a new sequence should be started.

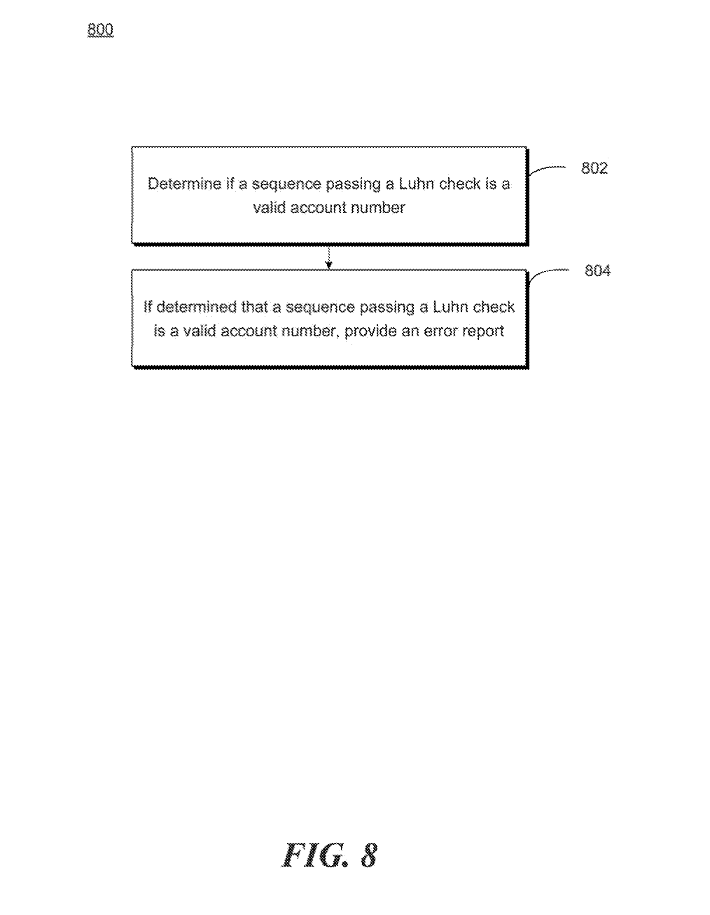

FIG. 8 is a flow chart illustrating one example of a method 800 to process a sequence of digits satisfying a Luhn check. Once a potential account number is identified, additional steps may be taken to determine whether the potential account number is an actual account number. For example, in some cases a number may pass a Luhn check even thought the number is not an account number. An error report may be provided indicating which potential account numbers are actual account numbers. The method 800 may be implemented, for example, using the apparatus 100.

Beginning at 802, a processor determines if a sequence passing a Luhn check is a valid account number. The processor may be the same or a different processor than the processor that determine whether a sequence passed a Luhn check. In one embodiment, the processor is the processor 104.

The processor may determine if a group of sequences passing a Luhn check are valid account numbers in any suitable manner. For example, the processor may compare a sequence to a known list of account numbers, such as a list of account numbers or hash values stored in a database. In one embodiment, the processor determines an entity, such as a credit card company, associated with the potential account number. For example, credit card numbers starting with a first number may be associated with a first company, and credit card numbers starting with a second number may be associated with a second company. The processor may determine a company associated with a potential account number, and transmit the potential account number to the associated company. The processor may receive information hack from the associated entity indicating whether the potential account number is a valid account number, such as an actual active account number.

Continuing to 804, if determined that a sequence passing a Luhn check is a valid account number, the processor provides an error report. The processor may generate an error report indicating a list of valid account numbers. The report may be transmitted, such as emailed to a network administrator. In some cases, the report may be displayed on a display device.

Determining consecutive sequences of digits of a selected length satisfying a Latin check in a single pass of a list of digits may be simpler and faster than other methods. In some cases, such a method may be simple enough to implement in hardware.

1. A machine-readable storage medium including instructions executable by a processor to identify potential account numbers in a single pass of as list of digits, comprising instructions to:
evaluate a digit in each consecutive position in the list, including:
determining a partial Luhn check for each position after the second position in the list by determining the sum of the digit in a current position, double the digit one position prior to the current position, and the partial Luhn check of a digit two positions prior to the current position;
adjusting the partial Luhn check where the digit in the current position is greater than four; and
completing the Luhn check for each position where the number of positions prior to the current position is greater than a selected length to determine whether a consecutive sequence of digits of the selected length ending with the digit in the current position passes the Luhn check; and
provide each consecutive sequence of digits of the length passing the Luhn check as potential account numbers.

2. The machine-readable storage medium of claim 1, wherein instructions to determine the partial Luhn check for each position further comprise instructions to add 1 to the sum where the digit one position prior to the current position is greater than 4.

3. The machine-readable storage medium of claim 1, wherein there are multiple selected lengths.

4. The machine-readable storage medium of claim 1 wherein completing the Luhn check for a position comprises instructions to;
subtract a partial Luhn check for a previous position from a partial Luhn check for the current position; and
perform a mod 10 operation.

5. The machine-readable storage medium of claim 4, wherein completing the Luhn check further comprises instructions to add a digit in a position prior to the position associated with the partial Luhn check for the previous position.

6. An apparatus to identify potential account numbers in a single pass of a list of digits, comprising:
a processor to:
receive a list of characters via a network;
evaluate the list of characters in a single pass to determine each consecutive sequence of digits of a selected length within the list of characters that satisfies a Luhn check based on a determined partially executed Luhn check for each position of a digit in the list of characters; and
provide each sequence of digits of the selected length determined to satisfy the Luhn check as potential account numbers.

7. The apparatus of claim 6, wherein determining whether each sequence of digits of a selected length within the list satisfies a Luhn check, comprises:
performing a partial Luhn check for each digit in the list after the second position, wherein the partial Luhn check is performed based on the digit in the current position in the list and a partial Luhn check related to a digit in a previous position in the list; and
completing the Luhn check if the selected length of digits is reached.

8. The apparatus of claim 6, wherein determining each consecutive sequence of digits of a selected length within the list of characters that satisfies a Luhn check further comprises determining each consecutive sequence of digits of a selected length separated by approved characters within the list of characters that satisfies a Luhn check.

9. The apparatus of claim 6, comprising multiple selected lengths.

10. The apparatus of claim 6, wherein the processor further determines whether the provided potential account numbers are valid account numbers.

11. A method to identify potential account numbers in a single pass of a list of digits, comprising
performing. by a processor, a single pass of a list of digits, including determining each consecutive sequence of digits of a selected length within the list that satisfies a Luhn check based on a determined partially executed Luhn check for each position in the list of digits; and
providing, by the processor, each sequence of digits of the length determined to satisfy the Luhn check as potential account numbers.

12. The method of claim 11, wherein determining each consecutive sequence of digits of a selected length within the list that satisfies a Luhn check, comprises
performing the partially executed Luhn check for each position in the list; and
completing the Luhn check for each position where the number of positions prior to the current position is greater than the selected length based on:
the partially executed Luhn check for the current position; and
a partially executed Luhn check for a previous position.

13. The method of claim 11, wherein determining each consecutive sequence of digits of a selected length within the list that satisfies a Luhn check comprises determining each consecutive sequence of digits and consecutive sequences of digits separated by approved characters that satisfy the Luhn check.

14. The method of claim 11, wherein determining whether a consecutive sequence of digits of a selected length satisfies a Luhn check comprises determining whether a consecutive sequence of 14, 15, or 16 digits satisfies a Luhn check.

15. The method of claim 11, further comprising:
determining if a sequence passing the Luhn check is a valid account number;
if determined that a sequence passing the Luhn check is a valid account number, providing an error report.
